(19) United States
(12) Patent Application Publication
(10) Pub. No.: US 2011/0319136 A1
(43) Pub. Date: Dec. 29, 2011

(54) Method of a Wireless Communication Device for Managing Status Components for Global Call Control

(75) Inventors: Michael P. Labowicz, Palatine, IL (US); Scott A. Macdonald, Chicago, IL (US); Stephanie M. McNee, Chicago, IL (US); Kazuhiro Ondo, Buffalo Grove, IL (US); John Touvannas, San Diego, CA (US)

(73) Assignee: MOTOROLA, INC., Schaumburg, IL (US)

(21) Appl. No.: 12/821,969

(22) Filed: Jun. 23, 2010

(51) Int. Cl. H04W 88/02

(52) U.S. Cl. 455/566

(57) ABSTRACT

There is described a method of a wireless communication device for managing status components for global call control. A selectable region is displayed at a display. A first user input is then detected at an input component associated with the display corresponding to selection of the selectable region. Next, an active call status component associated with a current call is displayed at the display in response to the first user input. A second user input is detected at the input component corresponding to selection of the current call status component. Thereafter, active call information associated with an active call is displayed at the display or an active call is terminated in response to detecting the second user input.

### RELATED APPLICATIONS

This application is related to U.S. application Ser. No. 12/612,069, filed Nov. 4, 2009, titled METHODS FOR STATUS COMPONENTS AT A WIRELESS COMMUNICATION DEVICE (Attorney Docket No. CS36778).

### FIELD OF THE INVENTION

The present invention relates generally to the field of user interfaces of wireless communication devices and, more particularly, to wireless communication devices having gesture-sensitive displays and providing status components.

### BACKGROUND OF THE INVENTION

Wireless communication devices designed for mobile users often have small screen displays. These small displays result in limited space for displaying content and receiving input from the user. This problem is particularly applicable to devices having touch-sensitive displays. For example, many graphical elements on a touch-sensitive display are sized too small in scale to discern the selection of one element from its neighboring elements via a finger touch.

In certain operating systems, such as the Open Handset Alliance™ Android™ operating system, it is common to see a toolbar region spanning the width of the screen. These toolbars typically include graphical icons and allow touch or gesture invocation of the toolbar region to generate a pull-down window list. This pull-down window list, however, only contains a subset of items representing notification of external events and associated with the graphical icons because of the lack of screen space.

The current solution to the problem of accessing the remaining subset of items is to provide separate menu structures. These menu structures are complicated and non-intuitive, having multi-level depth and requiring focused time and attention from users in the form of button presses, gestures, and screen taps for user interface navigation.

For example, some wireless communication devices display a battery strength icon on a default screen as a high-level view of the battery strength property. To view detailed information about the battery strength, however, the user is required to invoke a settings widget to launch a menu, select an “about phone” option, select a “status” option, and then select a “battery level” option. This example user/menu interaction illustrates the indirect and often confusing relationship between the battery strength icon and the detailed information behind this icon. A direct route is needed from the default screen icon representations to the displaying and if applicable altering of the wireless communication system properties represented by these icons.

### BRIEF DESCRIPTION OF THE DRAWINGS

FIG. 1 is front planar view of a wireless communication device in accordance with the present invention.

FIGS. 2A, 2B and 2C are example screen views of a first aspect of a wireless communication device in accordance with the present invention.

FIG. 3 is a block diagram of an example wireless communication device illustrating an environment of use for the present invention.

FIGS. 4A, 4B, 4C and 4D are example screen views of a second aspect of a wireless communication device in accordance with the present invention.

FIG. 5 is a flowchart diagram of example operations of the wireless communication device in accordance with the present invention.

### DETAILED DESCRIPTION OF THE EMBODIMENTS

There is described a wireless communication device having a display, in which a selection area is provided in a notification region of the display. Users of the wireless communication device are provided the capability of terminating their calls quickly from multiple places in the user interface of the device, including areas away from an in-call screen. Thus, users may easily access the selection area to terminate a call without having to access the in-call screen. The selection area, such as an end-call virtual button, on the notification bar reduces the number of steps required to end-a-call on a wireless communication device without a physical end-call key.

An aspect of the present invention is a method of a wireless communication device for managing status components for global call control. A selectable region is displayed at a display, such as a gesture-sensitive display. A first user input is then detected at an input component of the display, such as a gesture-sensitive display, corresponding to selection of the selectable region. Next, an active call status component associated with a current call is displayed at the display in response to the first user input. A second user input is detected at the input component corresponding to selection of the current call status component. Thereafter, active call information associated with an active call is displayed at the display or an active call is terminated in response to detecting the second user input.

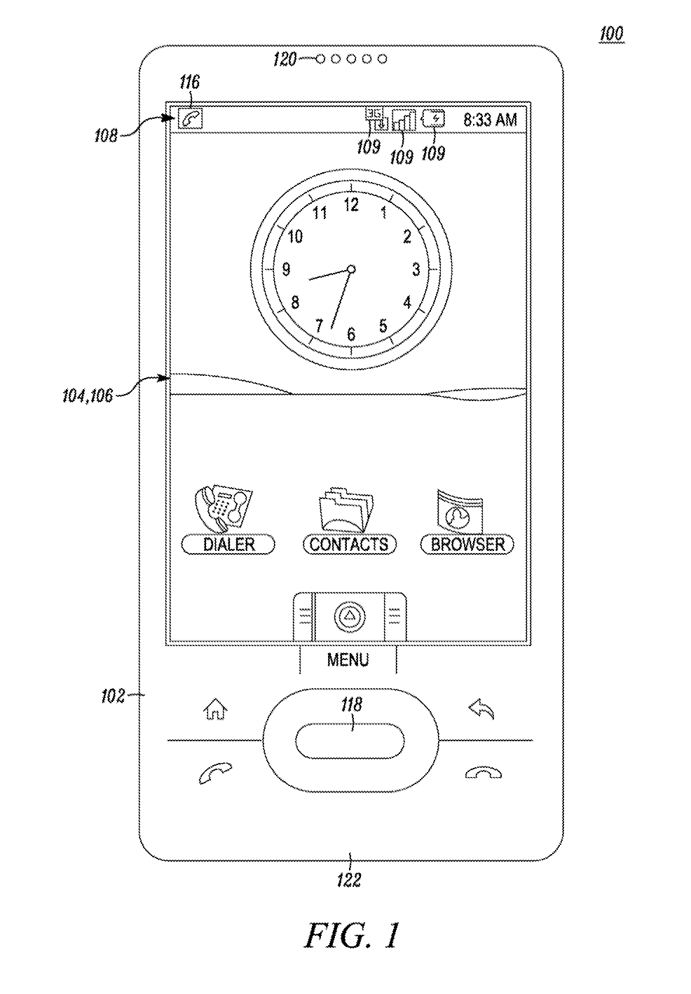

FIG. 1 illustrates a front planar view of an example wireless communication device 100. The wireless communication device 100 is preferably a portable radiotelephone; however, the wireless communication device 100 may be any device having a capability to communicate wirelessly, such as, but not limited to, a portable video player (PVP), wireless local area network (WLAN)-based mobile phones, a wireless personal digital assistant (PDA), a personal navigational device (PND), and a cordless telephone.

For one embodiment, the communication device 100 has a housing comprising a housing surface 102 which includes a visible display 104 and a user interface. For example, the user interface may be a touch-sensitive surface 106 that overlays the display 104. With the touch-sensitive surface 106 overlaying the display 104, the display may provide feedback associated with a predetermined gesture as the predetermined gesture is detected. For another embodiment, the user interface of the wireless communication device 100 may include the touch-sensitive surface 106 supported by the housing and does not overlay any type of display.

The display 104 of the wireless communication device 100 may provide a device notification bar 108 for indicating device status and/or general information like the one or more graphical icons 109, 116. The graphical icons 109, 116 may be a phone notification icon, a 3G status level status icon, a cellular signal strength status icon, a battery level status icon, or any other notification or status icon.

While the notification bar 108 is illustrated in FIG. 1 as having a width of 100% of the total width of the visible display 104 and a length of 1/10 of the total length of the visible display, one of ordinary skill in the art will note that the dimensions shown in FIG. 1 are illustrative of an example implementation and may be substantially different than those shown. Additionally, the location of the notification bar 108 may be at the top of the visible display 104 as shown in FIG. 1, however it may also be on the left side of the display, the right side of the display, the bottom of the display, free floating, or any other configuration that is convenient to the user of the wireless communication device 100.

The length, width, and location of the notification bar 108 may also be altered dynamically by the user. For example, a predefined gesture may be associated with moving the notification bar 108 from one location to another location and/or changing the length or width of the notification bar.

For yet another embodiment, the user interface of the wireless communication device 100 may include one or more input keys 118 used in conjunction with the touch-sensitive surface 106. Examples of the input key or keys 118 include, but are not limited to, keys of an alpha or numeric keypad, a physical keys, touch-sensitive surfaces, multipoint directional keys. The wireless communication device 100 may also comprise apertures 120, 122 for audio output and input at the surface. It is to be understood that the wireless communication device 100 may include a variety of different combination of displays and interfaces.

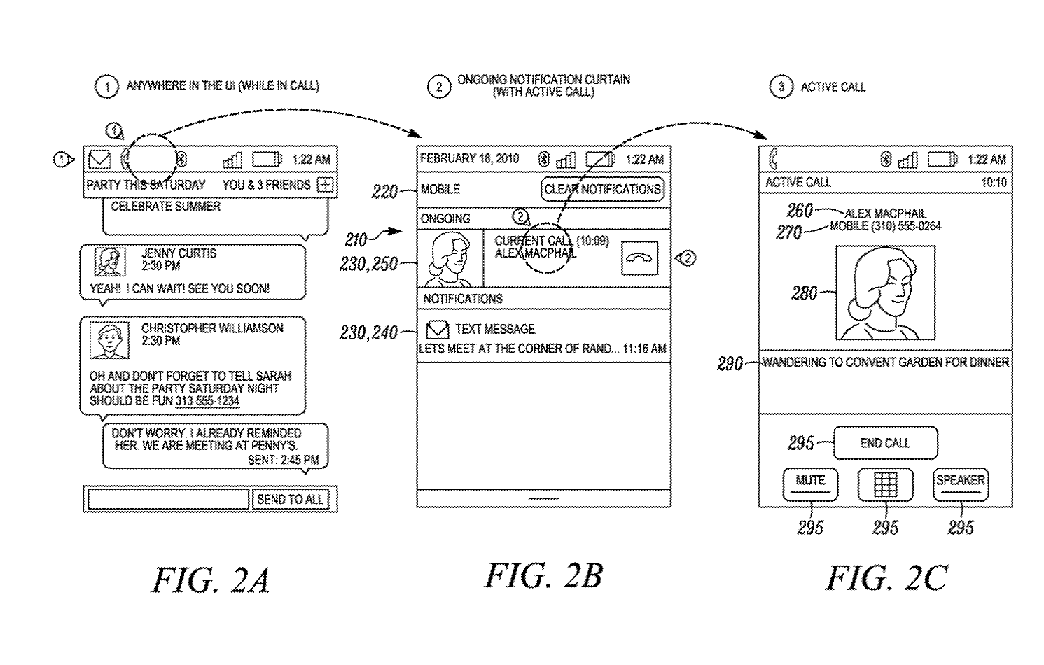

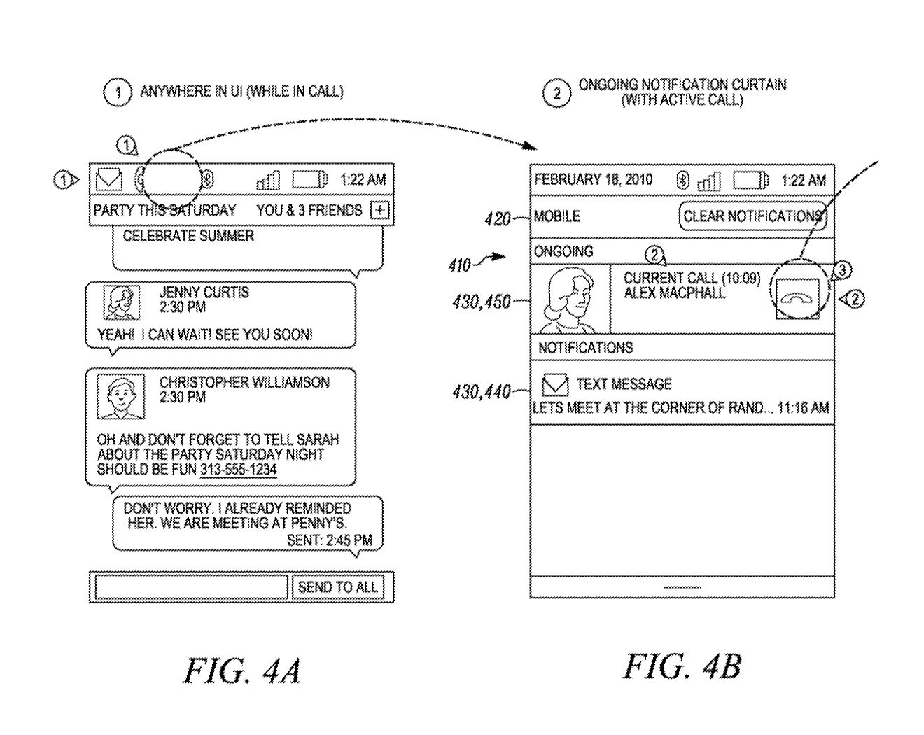

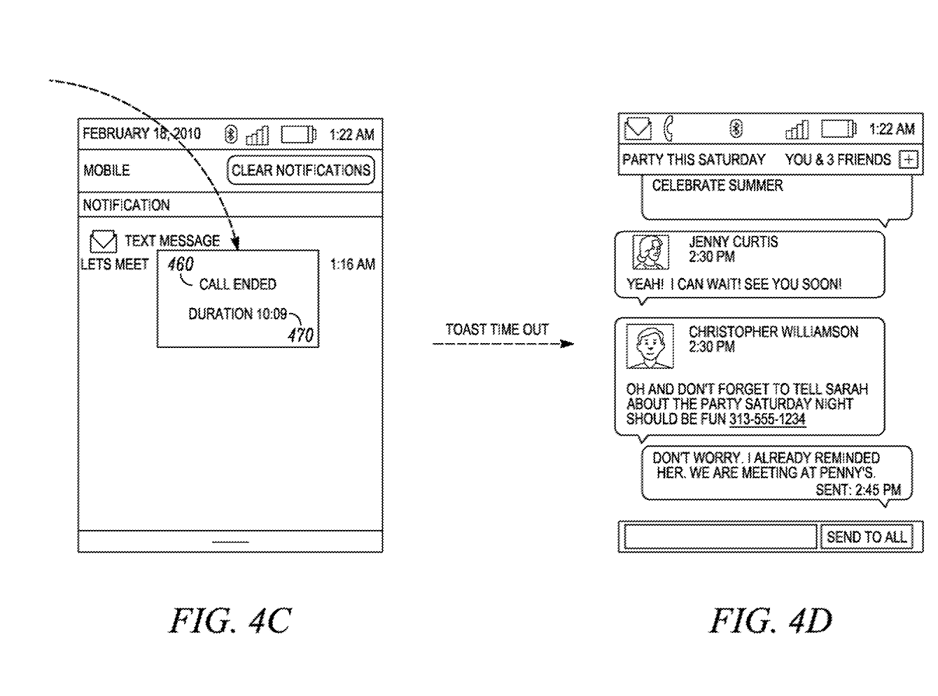

FIGS. 4A, 2B and 2C are example screen views of a first aspect of a wireless communication device in accordance with the present invention, in which the device returns the user to an active call from many locations or situations outside of the calling application. Thus, as a precursor to FIG. 2A, a call is conducted at the wireless communication device before displaying the selectable region at the display, in which the call is still pending when the selectable region is displayed. FIGS. 2A and 2B represent a transition to a graphical pull-down window 210. The graphical pull-down window 210 includes an application header section 220 for displaying the name of the window.

The graphical pull-down window 210 additionally includes one or more status components 230. The status components 230 represent one or more properties of the wireless communication device 100. For example, a status of the status component 240 is shown with a “Text Message” label representing that a text message has been received but not read by the user.

The graphical pull-down window 210 may additionally contain a launcher icon for invoking applications or functions stored on the wireless communication device 100 or for connecting to services and portals via wireless communication remote to the wireless communication device 100. For example, as shown in FIG. 2B, the graphical pull-down window 210 includes an active call status component 250 associated with a current call at the display.

Referring to FIG. 2C, detecting a user input at the input component corresponding to selection of the current call status component 250 results in displaying active call information associated with an active call at the display. Examples of active call information include, but are not limited to, party identification 260, communication identification 270, party image 280, party status 290, and functions associated with the current call 295.

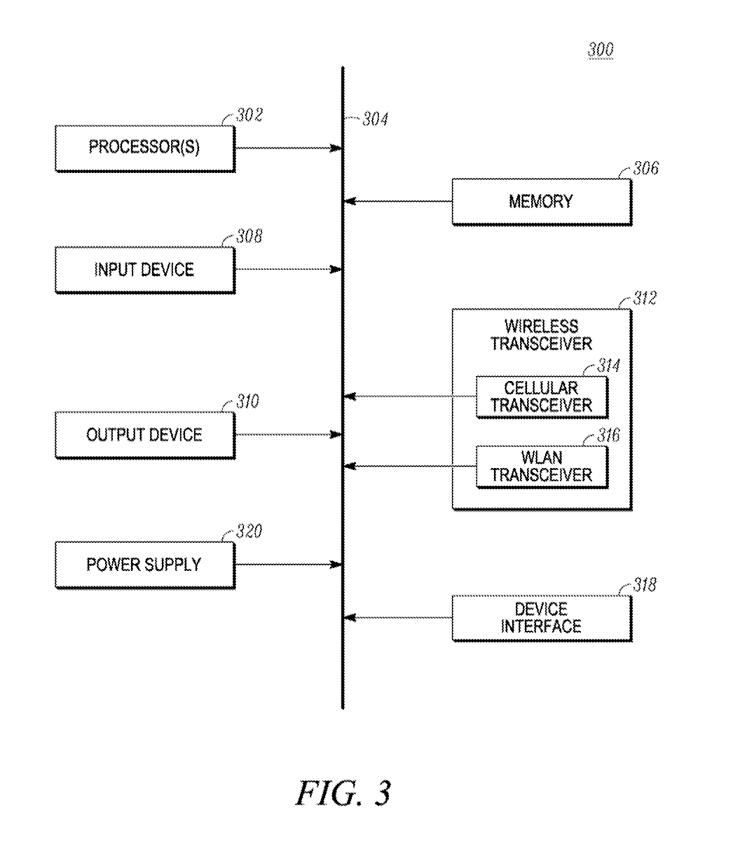

FIG. 3 illustrates an environment of use of a plurality of components 300 comprising a processor 302 electrically coupled by a system interconnect 304 to a memory device 306, an input component 308, an output component 310, and one or more wireless transceivers 312, such as a cellular transceiver 314, a WLAN transceiver 316, or any other transceiver device or combination of transceiver devices. Additionally, the components 300 includes one or more device interfaces 318 and a power source 320, such as a portable battery, for providing power to the other components and allowing portability of the wireless communication device 100.

The processor 302 provides central operation of the wireless communication device 100, such as receiving incoming data from and providing outgoing data to the wireless transceivers 312, accessing data from and storing data to the memory device 306, receiving input from one or more input component(s) 308, and providing output to one or more output component(s) 310.

The system interconnect 304 is shown in FIG. 3 as an address/data bus. Of course, a person of ordinary skill in the art will readily appreciate that interconnects other than busses may be used to connect the processor 302 to the other devices 306-320. For example, one or more dedicated lines and/or a crossbar may be used to connect the processor 302 to the other devices 306-320.

The memory device 306 operatively coupled to the processor 302 is a conventional memory device for storing data structures as well as software instructions executed by the processor 302 in a well known manner. Data may be stored by the memory device 306 include, but is not limited to, operating systems, applications, and data. Each operating system includes executable code that controls basic functions of the portable electronic device, such as interaction among the components of the components 300, communication with external devices via each wireless transceiver 312 and/or the device interfaces 320, and storage and retrieval of applications and data to and from the memory 306. Each application includes executable code utilizes an operating system to provide more specific functionality for the portable electronic device. Data is non-executable code or information that may be referenced and/or manipulated by an operating system or application for performing functions of the portable electronic device.

The memory 306 may store a plurality of gestures including the predetermined gesture. Thus, the processor 302 may retrieve information the memory 306 relating to one or more predetermined gestures, and correlate a gesture received at the user interface with one of the stored predetermined gesture.

The input component 308 may be connected to the processor 302 for entering data and commands in the form of text, touch input, gestures, etc. The input component 308 is, in one embodiment, a touch screen device but may alternatively be an infrared proximity detector or any input/output component combination capable of sensing gestures and/or touch including a touch-sensitive surface. The input component 308, may produce an input signal in response to detecting a predetermined gesture at the touch-sensitive surface. In addition, the input component 308 may include one or more additional components, such as a video input component such as an optical sensor (for example, a camera), an audio input component such as a microphone, and a mechanical input component such as button or key selection sensors, touch pad sensor, another touch-sensitive sensor, capacitive sensor, motion sensor, and switch.

The wireless communication device 100 may allow a user to provide a predetermined gesture, such as sliding one or more digits of the user's hand across a surface. Additionally or alternatively, contact with the surface without any movement along the surface such as a user press to a touch sensitive region may be provided as a gesture. Contact and movement on the surface followed by the invocation of one or more character or word recognition algorithm may be provided (e.g., one or more handwriting recognition algorithm may be implemented).

The output component 310 may generate visual indications of data generated during operation of the processor 302. The visual indications may include prompts for human operator input, calculated values, detected data, etc. As described in detail above in relation to FIG. 1, these visual indications include visual representations of the status components. Additionally, the output component 310 may include a video output component such as a cathode ray tube, liquid crystal display, plasma display, incandescent light, fluorescent light, front or rear projection display, and light emitting diode indicator. Other examples of output components 310 include an audio output component such as a speaker, alarm and/or buzzer, and/or a mechanical output component such as vibrating or motion-based mechanisms.

Each wireless transceiver 312 may utilize wireless technology for communication, such as, but are not limited to, cellular-based communications such as analog communications (using AMPS), digital communications (using CDMA, TDMA, GSM, iDEN, GPRS, or EDGE), and next generation communications (using UMTS, WCDMA, LTE, LTE-A or IEEE 802.16) and their variants, as represented by cellular transceiver 314.

Each wireless transceiver 312 may also utilize wireless technology for communication, such as, but are not limited to, peer-to-peer or ad hoc communications such as HomeRF, Bluetooth and IEEE 802.11 (a, b, g or n); and other forms of wireless communication such as infrared technology, as represented by the WLAN transceiver 316. Also, each wireless transceiver 312 may be a receiver, a transmitter or both.

The components 300 may further include one or more device interfaces 318 to provide a direct connection to auxiliary components or accessories for additional or enhanced functionality.

It is to be understood that FIG. 3 is provided for illustrative purposes only and for illustrating components of a portable electronic device in accordance with the present invention, and is not intended to be a complete schematic diagram of the various components required for a portable electronic device. Therefore, a portable electronic device may include various other components not shown in FIG. 3, or may include a combination of two or more components or a division of a particular component into two or more separate components, and still be within the scope of the present invention.

FIGS. 4A, 4B, 4C and 4D are example screen views of a second aspect of a wireless communication device in accordance with the present invention, in which the device terminates an active call from many locations or situations outside of the calling application. Again, as a precursor to FIG. 4A, a call is conducted at the wireless communication device before displaying the selectable region at the display, in which the call is still pending when the selectable region is displayed. FIGS. 4A and 4B represent a transition to a graphical pull-down window 410. The graphical pull-down window 410 includes an application header section 420 for displaying the name of the window.

The graphical pull-down window 410 additionally includes one or more status components 430. The status components 430 represent one or more properties of the wireless communication device 100. For example, a status of the status component 440 is shown with a “Text Message” label representing that a text message has been received but not read by the user.

The graphical pull-down window 410 may additionally contain a launcher icon for invoking applications or functions stored on the wireless communication device 100 or for connecting to services and portals via wireless communication remote to the wireless communication device 100. For example, as shown in FIG. 4B, the graphical pull-down window 410 includes an active call status component 450 associated with a current call at the display.

Detecting a user input at the input component corresponding to selection of the current call status component 250 results in termination of an active call in response to detecting the user input. The active call is made inactive, and the user is returned to the user's previous screen before detecting the user input corresponding to selection of the selectable region, as represented by FIG. 4D, or to a default screen. Optionally, the display may provide an acknowledgment of the call termination, as represented by FIG. 4C, before returning the user to the previous screen or a default screen. The acknowledgment may provide details about call status 460, call timing 470, and the like.

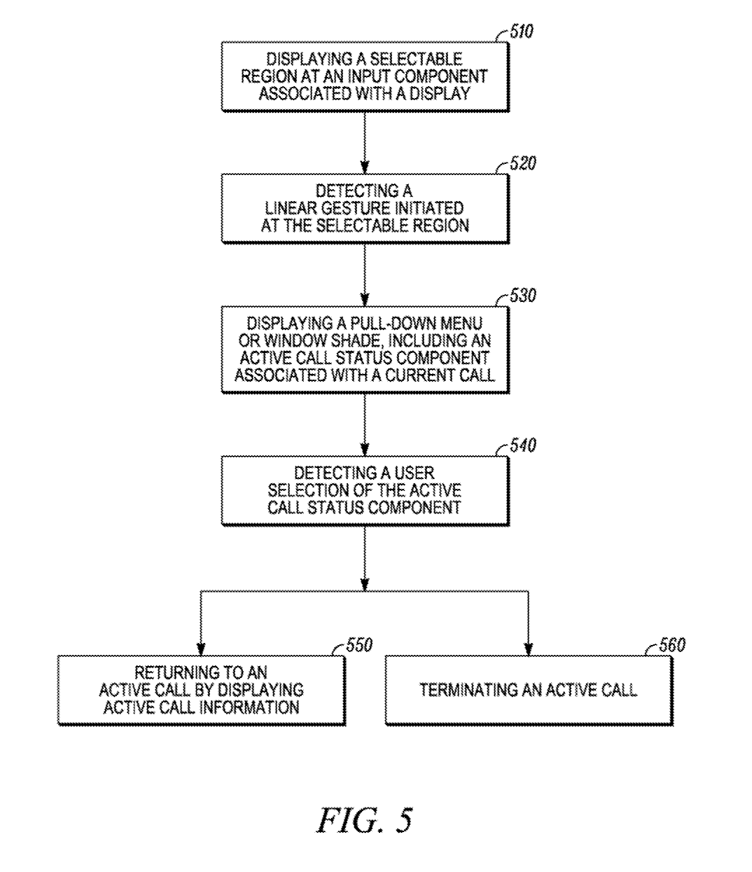

FIG. 5 is an example process 500 representative of example operation of a device and its components, such as the wireless communication device 100 represented by FIG. 1, and the components represented by FIG. 3, to implement a method for status components at a wireless communication device. For one embodiment, the illustrated process 500 may be embodied in one or more software programs which are stored in one or more memories (e.g., memory 306) and executed by one or more processors (e.g., processor 302). However, at least some of the blocks of the process 500 may be performed manually and/or by some other device. Although the process 500 is described with reference to the flowchart illustrated in FIG. 5, a person of ordinary skill in the art will readily appreciate that many other variations of performing the process Error! Reference source not found.00 may be used without diverting from the scope of the present invention. For example, the order of many of the blocks may be altered, the operation of one or more blocks may be changed, blocks may be combined, and/or blocks may be eliminated.

Generally, the process 500 causes the processor 302 to display and allow access to status components at the wireless communication device 100. Starting at step 510, the wireless communication device 100 displays a selectable region at a gesture-sensitive display or, more specifically, an input component of the display.

The user may select a region at step 520 in a variety of ways. For example, the user input may be a linear gesture initiated proximate the selectable region and directed away from the selectable region. If a user selects a region at step 520, the wireless communication device 100 proceeds to step 530 where an active call status component associated with a current call is displayed at the display. For one embodiment, the wireless communication device 100 displays multiple status components including the active call status component at the visible display 104. For another embodiment, a graphical window may be shown that enlarges as the linear gesture is directed away from the selectable region, in which the active call status component is shown in the graphical window. The technique for displaying the graphical window may include displaying a pull-down menu or window shade-like window.

After displaying the active call status component, the input component may detecting a second user selection in which the active call status component is selected at step 540. In response to selection of the active call component, the process 500 may continue in one of a variety of ways. For one embodiment, the display may provide active call information associated with an active call at the display in response to detecting the second user input at step 550. In other words, the wireless communication device may return to an active call screen so that the user may view details about the current call and/or selection a function associated with the current call. For another embodiment, the processor and/or transceiver of the wireless communication device may terminate an active call in response to detecting the second user input at step 560.

Although the above discloses example systems including, among other components, software executed on hardware, it should be noted that such systems are merely illustrative and should not be considered as limiting. For example, it is contemplated that any or all of the disclosed hardware and software components could be embodied in dedicated hardware, in software, in firmware or in some combination of hardware, firmware and/or software.

In addition, although certain methods, apparatus, and articles of manufacture have been described herein, the scope of coverage of this patent is not limited thereto. On the contrary, this patent covers all apparatuses, methods and articles of manufacture fairly falling within the scope of the appended claims either literally or under the doctrine of equivalents.

What is claimed is:

1. A method of a wireless communication device for managing status components for global call control, the method comprising:
displaying a selectable region at a display;
detecting a first user input at an input component associated with the display corresponding to selection of the selectable region;
displaying an active call status component associated with a current call at the display in response to the first user input;
detecting a second user input at the input component corresponding to selection of the current call status component; and
displaying active call information associated with an active call at the display in response to detecting the second user input.

2. The method of claim 1, further comprising conducting a call at the wireless communication device before displaying the selectable region at the display, wherein the call is still pending when the selectable region is displayed.

3. The method of claim 1, wherein the active call status component further includes a second indicator corresponding to a non-current call.

4. The method of claim 3, wherein the non-current call is at least one of a wireless status, a volume status, or a battery status.

5. The method of claim 1, wherein the first user input is a linear gesture initiated proximate the selectable region and directed away from the selectable region.

6. The method of claim 6, wherein displaying an active call status component associated with a current call at the display includes showing a graphical window that enlarges as the linear gesture is directed away from the selectable region, wherein the active call status component is shown in the graphical window.

7. The method of claim 1, wherein the selectable region encompasses a total width of the display.

8. The method of claim 1, further comprising:
detecting whether the current call has been terminated; and
removing the active call status component from the display in response to detecting that the current call has been terminated.

9. A method of a wireless communication device for managing status components for global call control, the method comprising:
displaying a selectable region at a display;
detecting a first user input at an input component associated with the display corresponding to selection of the selectable region;
displaying an active call status component associated with a current call at the display in response to the first user input;
detecting a second user input at the display corresponding to selection of the current call status component; and
terminating an active call in response to detecting the second user input.

10. The method of claim 1, further comprising conducting a call at the wireless communication device before displaying the selectable region at the display, wherein the call is still pending when the selectable region is displayed.

11. The method of claim 1, wherein the active call status component further includes a second indicator corresponding to a non-current call.

12. The method of claim 3, wherein the non-current call is at least one of a wireless status, a volume status, or a battery status.

13. The method of claim 1, wherein the first user input is a linear gesture initiated proximate the selectable region and directed away from the selectable region.

14. The method of claim 6, wherein displaying an active call status component associated with a current call at the display includes showing a graphical window that enlarges as the linear gesture is directed away from the selectable region, wherein the active call status component is shown in the graphical window.

15. The method of claim 1, wherein the selectable region encompasses a total width of the display.
